(19) United States
(12) Patent Application Publication
(10) Pub. No.: US 2016/0215829 A1
(43) Pub. Date: Jul. 28, 2016

(54) SWITCHING UNIT WITH AN INTERNAL DIAMETER AND AN EXTERNAL DIAMETER ABOUT A ROTATIONAL AXIS FOR A MAIN COUPLING

(71) Applicant: SCHAEFFKER TECHNOLOGIES AG & CO. KG, Herzogenaurach (DE)

(72) Inventor: Florian Vogel, Buhl (DE)

(73) Assignee: Schaeffler Technologies AG & Co. KG, Herzogenaurach (DE)

(21) Appl. No.: 14/914,152

(22) PCT Filed: Oct. 20, 2014
(86) PCT No.: PCT/DE2014/200571

§ 371 Date: Feb. 24, 2016

(30) Foreign Application Priority Data
Nov. 13, 2013 (DE) 10 2013 223 044.3
Mar. 28, 2014 (DE) 10 2014 205 859.7

(51) Int. Cl. F16D 13/52; F16D 21/08; F16H 25/18

(52) U.S. Cl. CPC F16D 13/52; F16H 25/186; F16D 21/08

(57) ABSTRACT

The invention relates to a switching unit with an internal diameter and an external diameter about a rotational axis for a main coupling, having at least the following components: a first rotational element with at least one ramp with at least one rolling element; and a second rotational element. The first rotational element and said second rotational element are arranged spaced apart from each other by the at least one rolling element so as to transmit a pressure force. The distance between the first rotational element and the second rotational element can be adjusted by moving the at least one rolling element onto the at least one ramp. In particular, the switching unit is characterized in that the at least one ramp is arranged in a spiral manner from the external diameter to the internal diameter. Through the proposed switching unit, it is possible to individually adjust the ramp gradient over a wide range, and a low ramp gradient can be set at the same time.

### BACKGROUND

The invention relates to a switching unit with an internal diameter and an external diameter about an axis of rotation for a main clutch as well as a main clutch and a friction clutch, particularly a booster clutch or an E-clutch for a motor vehicle.

A switching unit is known from prior art in which two disks are provided, between which three identical balls are arranged extending on three identical ramps. The ramps are each provided mirror-oppositely on the first disk and the second disk, with these ramps extending on a common circle (concentrically and having the same radius) behind one another over an angle of 120° each. This way the gradient of the ramps is limited to a short distance at a desired stroke.

### SUMMARY

Based thereon, the present invention is given on the objective to at least partially overcome the known disadvantages of prior art. The objective is attained by the features of the independent claims. Advantageous further developments are the objective of the dependent claims.

The invention relates to a switching unit with an internal diameter and an external diameter about an axis of rotation for a main clutch, which has at least the following components:
a first rotational element with at least one ramp for at least one rolling element; and
a second rotational element,

with the first rotational element and the second rotational element being spaced apart from each other by the at least one rolling element in a manner that pressure force is transmitted, and here the distance between the first rotational element and the second rotational element can be changed via a motion of the at least one rolling element on at least one ramp. The switching unit is primarily characterized in that at least one ramp is arranged spirally from the external diameter to the internal diameter.

The switching unit is particularly provided for the purpose of transmitting a switching signal from a pilot clutch to a main clutch and here simultaneously generating a necessary compression force upon the main clutch. For this purpose, a first rotational element is provided on which at least one ramp with at least one rolling element is provided, particularly preferred three ramps with one rolling element each. Furthermore, opposite thereto a second rotational element is provided, and here the at least one rolling element can be clamped in a rolling fashion on at least one ramp between the first and the second rotational element. This way it is possible to transmit a pressure force from the first rotational element to the second rotational element. Due to the motion of the rolling element on at least one ramp the distance is changed between the first rotational element and the second rotational element. Thus, an actuating motion is performed, by which the actuation force can be transmitted to the main clutch. Here, it is pointed out that the actuating force originating from the switching unit is generated by the torque applied at the switching unit. The transmission of pressure force therefore serves, on the one hand, to clamp at least one rolling element and, on the other hand, to support the actuating force generated by the torque. The switching unit is therefore a converter for a torque applied in an axial, thus translational actuating force in the direction of the axis of rotation.

Particularly preferred, the actuating motion is implemented by a rotation of at least one of the rotational elements and/or a relative rotation between the first rotational element and the second rotational element by at least one rolling element rolling on at least one ramp. For example, the first rotation element is made to rotate by an actuation of a pilot clutch, while the second rotational element rotates at least slower and thus a relative rotation occurs between the first rotational element and the second rotational element. This way, at least one rolling element is moved on at least one ramp, and by the ramp gradient the second rotational element is moved away from the first rotational element, for example, so that the distance increases. The second rotational element then acts upon the main clutch such that the main clutch is switched due to the change in distance. The tripping force required is here generated by the torque which causes the relative motion between the first rotational element and the second rotational element. However, configurations are also possible in which an inverse transmission of torque can occur.

Here, at least one ramp is arranged spirally from the external diameter to the internal diameter, i.e. the ramps forms a gradual curve that can be differentiated, in which the radius is a (strictly monotonous) function of the angle. For example, the spiral may represent an Archimedean spiral, in which the radius from the internal diameter to the external diameter increases proportionally over the angle. In another application the spiral represents a logarithmic curve, in which the radius increases exponentially over the angle from the internal diameter to the external diameter. However, more complicated curve progressions are possible as well, with the curve always being a continuous one.

It is particularly preferred for the spiral to start directly at the internal diameter and end directly at the external diameter of the annular first rotational element.

Particularly preferred, the ramp inclines from the internal diameter to the external diameter so that centripetal force acting upon the rolling element is used in a supporting fashion in order to increase the distance between the first rotational element and the second rotational element. By the spiral shape it is possible to form a longer ramp than common in prior art and to adjust the gradient of the ramp to the force that needs to be transmitted. It is particularly advantageous for the spiral to extend over more than 120°, for example over 360°.

According to another advantageous embodiment of the switching unit a plurality of ramps is provided on the first rotational element, with the ramps being spirally nesting in each other.

When providing a plurality of ramps, here a particularly homogenous transmission of force is possible from the first rotational element to the second rotational element, with at least one rolling element being provided on every ramp. The ramps are here preferably nested in each other such that for example in case of three ramps every ramp is offset by 120°, beginning at the external diameter, and also ends offset by respectively 120° at the internal diameter. Here, all ramps are identical to each other with regards to gradient and shape of curvature.

According to another advantageous embodiment of the switching unit, at least one counter-ramp is provided on the second rotational element, corresponding to a ramp of the first rotational element, with the counter-ramp showing a spiral form mirror-opposite in reference to the corresponding ramp and the same direction of gradient from the internal diameter to the external diameter.

By providing a matching, mirror-opposite counter-ramp in the second rotational element the ramp gradient in the respective rotational element can be reduced, resulting in an identical or greater distances. It is particularly preferred for the ramp gradient to be identical in the mirror-opposite ramps. It is particularly preferred when each ramp has a progression over more than 120°, preferably over 360°, so that a simple nesting of the spirals in each other is possible. Furthermore, the switching unit shows preferably plate-shaped rotational elements, which are formed as flat as possible so that the axial structural length along the axis of rotation is as short as possible.

According to another advantageous embodiment of the switching unit at least one rolling element is spherical and at least one ramp, and preferably also the respectively corresponding counter-ramp, form a corresponding arc-shaped recess.

By the spherical shape of the rolling element a lateral guidance of the rolling element is possible, which is achieved by the arc-shaped recess. Particularly preferred, the counter-ramp is formed such that the first rotational element and the second rotational element are guided by the rolling element towards each other and/or, when the first rotational element and the second rotational element are guided, jointly the rolling element is guided securely. The corresponding arc-shape is here formed such that it has the radius (plus the required play) of the rolling element.

According to another aspect of the invention a main clutch for transmitting a torque is suggested by switching a pilot clutch, which shows at least the following components:
a first friction system with a first compression plate and at least one corresponding first friction disk, by which a first torque can be transmitted in the compressed state;
a switching unit according to one of the previous claims, implemented to actuate the first compression plate by the changed distance between the first rotational element and the second rotational element.

The first friction system is here provided such that due to high compression force a strong torque can be transmitted. The compression force is transmitted from the compression plate to at least one corresponding friction disk so that a disengageable torque can be transmitted. Here, the main clutch is advantageously embodied such it can transmit a stronger torque than the pilot clutch. This way, the pilot clutch can be operated with relatively weak tipping forces, which are sufficient to operate the switching unit. The required compression force for the first friction package is provided by the switching unit by the distance between the first rotational element and the second rotational element being changed. This change is generally achieved by a pilot clutch and/or the torque transmitted by the pilot clutch.

According to another aspect of the invention a friction clutch is suggested with an axis of rotation for the detachable connection of a driven shaft to a drive train, showing at least the following components:
a pilot clutch with a second friction system having a second compression plate and at least a corresponding second friction disk, by which a second torque can be transmitted in the compressed state;
an actuating device for actuating the pilot clutch;
a main clutch, whereby the switching unit can be operated via the pilot clutch such that the distance between the first rotational element and the second rotational element can be changed and thus the main clutch can be actuated.

The friction clutch comprises a pilot clutch, by which via the switching unit the main clutch can be switched. For this purpose, the pilot clutch comprises a second friction system, by which with a relatively low actuating force via the actuation device of the pilot clutch the second compression plate can be pressed against at least one corresponding second friction disk and this way transmits a second torque. This second torque is generally weaker than the first torque. By transmitting the second torque in the pilot clutch the switching unit is actuated, i.e. for example the first rotational element is set to rotate and thus at least one rolling element is moved on at least one ramp so that the distance is changed between the first rotational element and the second rotational element, for example increased. In this example, then an actuating force is applied upon the main clutch, as described above, so that the first compression plate is pressed against at least one corresponding first friction disk and a first torque can be transmitted. Such a friction clutch is used for example as a so-called booster clutch in motorcycles, so that a lower manual switching force is required and simultaneously strong compression force is generated by the torque of the motor and thus strong torque can be transmitted. Such friction clutches are also used as so-called e-clutches, by which for example energy is recuperated during coasting, thus the torque originating in the drive train of the motor vehicle is converted into electric energy by an optionally integrated generator.

According to another aspect of the invention a motor vehicle is suggested which comprises a drive unit with a driven shaft, a drive train, and a friction clutch according to the above-stated description.

Today, most motor vehicles have front-wheel drive and thus preferably arrange the drive unit, for example an internal combustion engine or an electric motor, in front of the cab and perpendicular to the primary driving direction. The structural space is particularly small in such an arrangement and therefore it is particularly advantageous to use a friction clutch of small structural size, which however can transmit strong torque. Additionally, motorcycles offer little structural space and the clutch force must remain very low at the manual controls of prior art.

The situation regarding the structural space in passenger vehicles of the compact vehicle class according to European classification is aggravated. The accessories used in a passenger vehicle of the compact class are not considerably smaller compared to passenger vehicles of larger vehicle classes. However, the space available in compact vehicles is considerably smaller. The friction clutch suggested here with a pilot clutch, switching unit, and main clutch allows a beneficial introduction of actuating force, which can be adjusted to the individual needs of the motors used and the switching behavior. For example, low clutch forces for the drivers can be transmitted into strong compression forces. This is advantageous particularly for compact vehicles, particularly those with an e-clutch, and motorcycles.

Passenger vehicles are allocated to a vehicle class, for example according to size, price, weight, power, with these definitions being subject to constant change according to the needs of the market. In the US-market vehicles of the classification small cars and compact cars according to the European classification are allocated to the class of subcompact cars and in the British market they are equivalent to the class of supermini, for example the class of city car. Examples of subcompact cars are a Volkswagen Fox or a Renault Twingo. Examples of compact cars are a Alfa Romeo Mito, Volkswagen Polo, Ford Fiesta, or Renault Clio.

The individual features listed in the claims can be combined arbitrarily in a technically beneficial fashion and can be supplemented by explanatory facts from the description and detail of the figures, in which additional exemplary embodiment variants of the invention are shown.

### BRIEF DESCRIPTION OF THE DRAWINGS

In the following, the invention and the technical background are explained in greater detail based on the figures. The figures show particularly preferred exemplary embodiments; however, the invention is not limited thereto. In particular, it must be pointed out that the figures and particularly the dimensions shown are only schematic. Shown are:

FIG. 1: a conventional switching unit in a cross-section;

FIG. 2: a first rotational element with a spiral first ramp;

FIG. 3: a cross-section through a first rotational element with a spiral first ramp;

FIG. 4: a first rotational element with three spiral ramps;

FIG. 5: a cross-section through a first rotational element with three spiral ramps,

FIG. 6: a switching unit with minimum distance;

FIG. 7: a switching unit with maximum distance;

FIG. 8: a friction clutch with a pilot clutch, switching unit, and main clutch; and

FIG. 9: a motorcycle with a manually switched friction clutch.

### DETAILED DESCRIPTION OF THE PREFERRED EMBODIMENTS

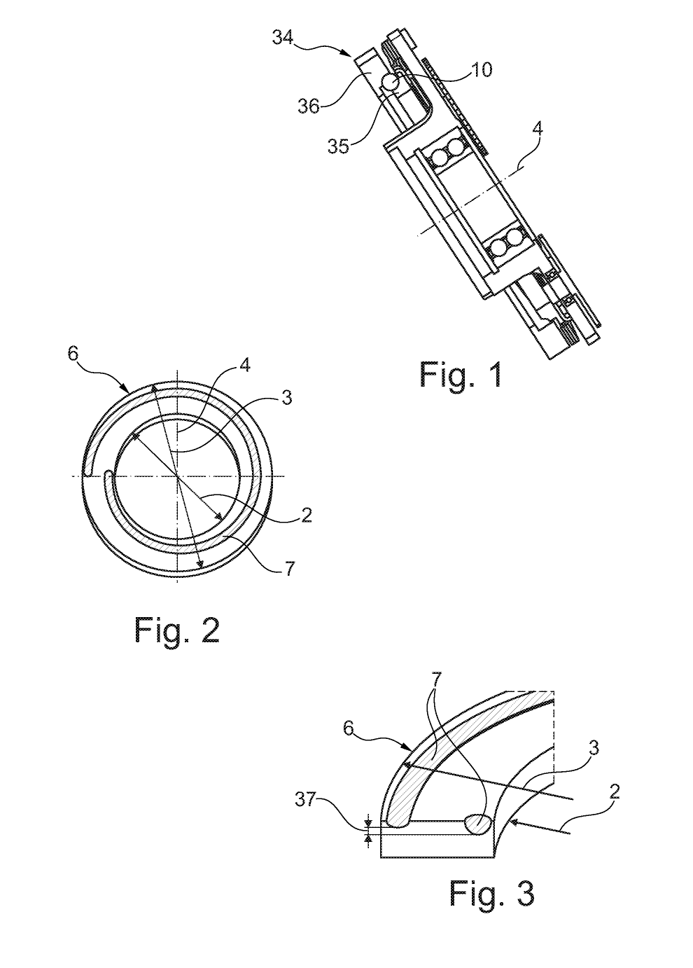

FIG. 1 is a conventional switching unit 34 with a conventional ramp disk 35 and with a conventional counter-ramp disk 36, with a rolling element 10 being arranged between them, which can be articulated about the axis of rotation 4 on concentric ramps.

FIG. 2 shows a first rotational element 6 with a spiral first ramp 7. The ramp extends from the external diameter 3 to the internal diameter 2 about the axis of rotation 4 over a total angle of 360°, with the radius of the spiral form constantly reducing. In this schematic example the ends of the first ramp 7 each abut the external perimeter 3 and/or the internal perimeter 2.

FIG. 3 shows a cross-section through a first rotational element 6 with a spiral first ramp 7, as discernible for example from FIG. 2. Here it is discernible that the first ramp 7 shows a ramp gradient 37 over its progression, which constantly increases from a lower end at the internal diameter 2 to a higher end at the external perimeter 3. The first ramp 7 is here embodied as an arc-shaped recess, which is suitable to guide a spherical rolling element 10 (cf. FIGS. 6 and 7).

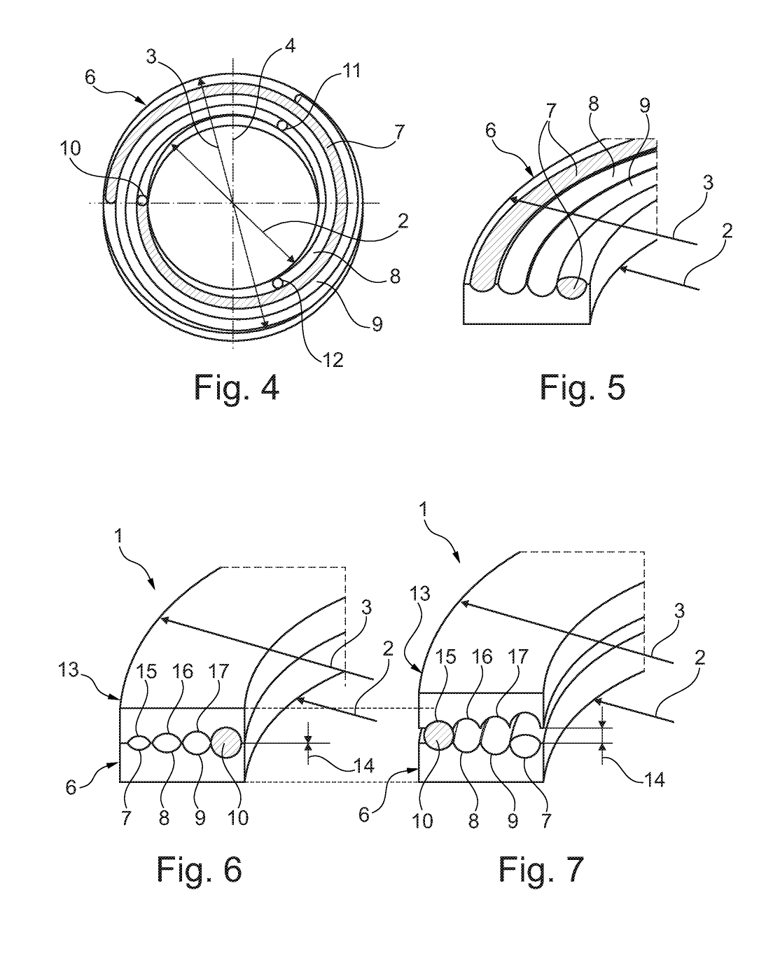

FIG. 4 shows a first rotational element 6 as seen in FIG. 2, with here a first ramp 7, a second ramp 8, and a third ramp 9 being arranged nested in each other and respectively comprising a first rolling element 10, a second rolling element 11, and/or a third rolling element 12 at the end at the internal perimeter 2. In the present example the ramps 7, 8, and 9 are each arranged offset about the axis of rotation by 120° in reference to each other.

FIG. 5 shows a cross-section through a first rotational element 6 with the three ramps 7, 8, and 9 as seen in FIG. 4. Here it is discernible that the ramps respectively form the same constant gradient from a lower end at the internal diameter 2 to a higher end at the external diameter 3.

FIGS. 6 and 7 show a switching unit 1 with a first rotational element 6 and a corresponding second rotational element 13, with the ramps 7, 8, and 9 each being embodied mirror-symmetrical in reference to the counter-ramps 15, 16, and 17. In FIG. 6 the first rolling element 10 is located in a minimum position at the internal diameter 2, so that due to the ramp gradient the distance 14 is minimal between the first rotational element 6 and the second rotational element 13. In FIG. 7 the first rolling element 10 is in the maximum position at the external diameter 3 so that the distance 14 is maximal. A desired maximum distance can be adjusted in a wide range with the ramps 7 to 9 and the counter-ramps 15 to 17 and simultaneously showing a low gradient here, which leads to a soft clutch or declutch process, depending on the configuration.

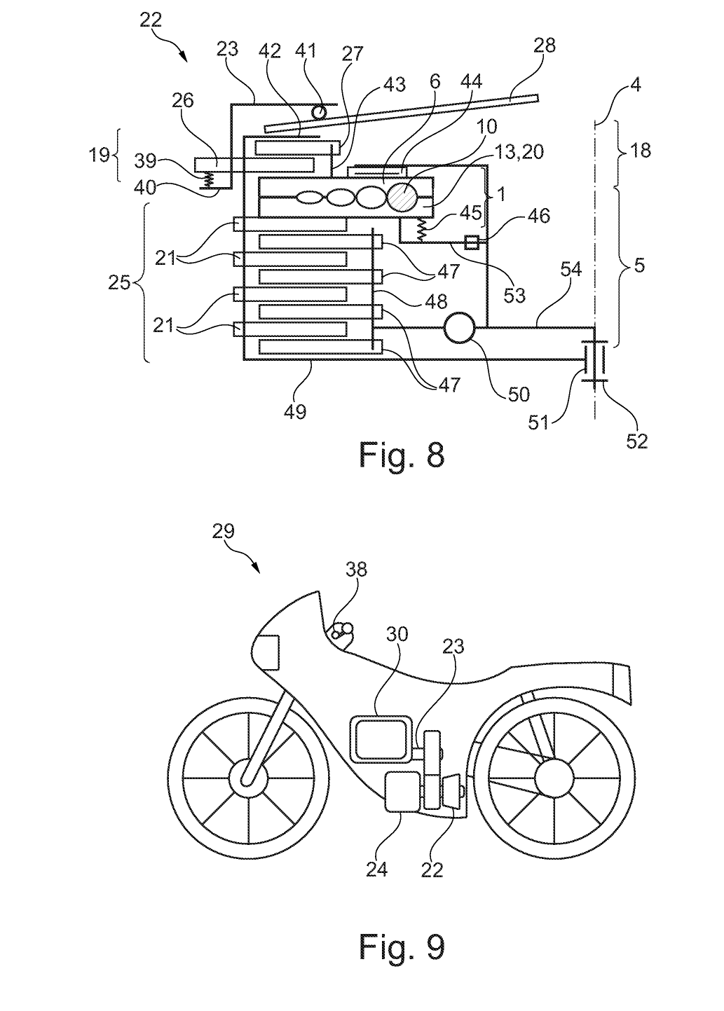

FIG. 8 shows in a schematic fashion a friction clutch 22 with a pilot clutch 18, a switching unit 1, and a main clutch 5. Such a friction clutch 22 is embodied for example as a so-called booster clutch, in which the pilot clutch 18 can be switched with low actuating forces using the actuating device 28, causing the switching unit 1 to be actuated and, with the help of the applied second torque of the pilot clutch 18, applies sufficient compression force is applied upon the main clutch 5. This way, a considerably stronger first torque can be transmitted via the main clutch 5.

The pilot clutch 18 comprises an actuating device 28, here a flat spring, which rests on a bearing 41 at a driven shaft 23, here a clutch cover. By the actuating device 28 the second compression plate 26 is pressed via the cover brim 40 and the spring element 39 against the second friction disk 27. The second friction disk 27 now entrains the first rotational element 6 via a connection element 43. The rolling elements, with here only the first roll 10 being discernible, are moved outwardly due to a relative rotation in reference to the second rotational element 13, which here forms in one piece the first compression plate 20 of the main clutch 5 and thus press the first compression plate 20 against the first friction disks 21 and the interim disks 47. In this example, the first friction disks 27 are already pre-accelerated by the second friction disk 21 via the support disk 42 and the external clutch cage 49, so that the relative speed is reduced in reference to the switching unit 1. The interim disks 47 transfer the torque from the driven shaft 23 via the internal clutch cage 48 to the output shaft 52. The switching unit 1 is arranged at a switching unit receptacle 54, in which the first rotational element 6 is supported via a needle bearing 44 and the second rotational element 13 via a retention spring 45 and a rotation spring 46 is connected to the compression plate receptacle 53 of the switching unit receptacle 54.

FIG. 9 shows a motor vehicle 29, here a motorcycle, with a drive unit 30, which is disengageably connected with its driven shaft via a friction clutch 22 to a drive train 24. The friction clutch 22 is here designed, for example, like in FIG. 8 and can easily be coupled to a manual lever 38, while simultaneously high torque can be transmitted with strong compression forces.

With the suggested switching unit an individual adjustment of the ramp gradient is possible over a wide range, with simultaneously allowing the setting of a lower ramp gradient.

### LIST OF REFERENCE CHARACTERS

1 switching unit
2 internal diameter
3 external diameter
4 axis of rotation
5 main clutch
6 first rotational element
7 first ramp
8 second ramp
9 third ramp
10 first rolling element
11 second rolling element
12 third rolling element
13 second rotational element
14 distance
15 first counter-ramp
16 second counter-ramp
17 third counter-ramp
18 pilot clutch
19 first friction system
20 first compression plate
21 first friction disk
22 friction clutch
23 driven shaft
24 drive train
25 second friction system
26 second compression plate
27 second friction disk
28 actuating device
29 motor vehicle
30 drive unit
31 cab
32 longitudinal axis
33 motor axis
34 conventional switching unit
35 conventional ramp disk
36 conventional counter-ramp disk
37 ramp gradient
38 manual switching lever
39 compensation spring
40 cover brim
41 bearing
42 support disk
43 connection element
44 needle bearing
45 return spring
46 rotation spring
47 interim disk
48 internal clutch cage
49 external clutch cage
50 torque sensor
51 clutch cage bearing
52 outlet shaft
53 compression plate receptacle
54 switching unit receptacle

1. A switching unit with an internal diameter and an external diameter about an axis of rotation for a main clutch, comprising:
a first rotational element with at least one ramp having at least one rolling element; and
a second rotational element,
with the first rotational element and the second rotational element being spaced apart from each other by the at least one rolling element in a pressure-transmitting fashion, with a distance between the first rotational element and the second rotational element being adjustable with a motion of the at least one rolling element on the at least one ramp, and
the at least one ramp is arranged spirally from the external diameter to the internal diameter.

2. The switching unit according to claim 1, wherein a plurality of the ramps are provided on the first rotational element, with the ramps being nested in each other in a spiral fashion.

3. The switching unit according to claim 1, wherein on the second rotational element at least one counter-ramp is provided corresponding to the at least one ramp of the first rotational element, with the at least one counter-ramp having a spiral form mirror-opposite in reference to the corresponding ramp and an even gradient from the internal diameter to the external diameter.

4. The switching unit according to claim 1, wherein the at least one rolling element is spherical and the at least one ramp includes a corresponding arc-shaped recess.

5. A main clutch for transmitting a torque by switching of a pilot clutch, comprising:
a first friction package with a first compression plate and at least one corresponding first friction disk, by which a first torque is transmitted in a compressed state;
a switching unit according to claim 1 that actuates the first compression plate by the adjustable distance between the first rotational element and the second rotational element.

6. A friction clutch with an axis of rotation for the disengageable connection of a driven shaft to a drive train, comprising:
a pilot clutch with a second friction system having a second compression plate and at least one corresponding second friction disk by which a second torque is transmitted in a compressed state;
an actuation device for actuating the pilot clutch;
a main clutch according to claim 5,
with the switching unit being adjustable via the pilot clutch such that the distance between the first rotational element and the second rotational element is changeable and thus the main clutch is actuated.

7. A motor vehicle comprising a drive unit with the driven shaft, the drive train, and the friction clutch according to claim 6.
